(19) United States
(12) Patent Application Publication
(10) Pub. No.: US 2022/0065654 A1
(43) Pub. Date: Mar. 3, 2022

(54) SYSTEM AND METHOD FOR PREDICTION OF GEO-COORDINATES FOR A GEOGRAPHICAL ELEMENT

(71) Applicant: Flipkart Internet Private Limited, Karnataka (IN)

(72) Inventors: Devanapalli Ravi SHANKAR, Karnataka (IN); Priyam TEJASWIN, Karnataka (IN); Gowtham BELLALA, Karnataka (IN); Govind PANDEY, Karnataka (IN)

(21) Appl. No.: 17/459,512

(22) Filed: Aug. 27, 2021

(30) Foreign Application Priority Data
Aug. 28, 2020 (IN) 202041037199

(51) Int. Cl. G01C 21/00; G06N 5/04; G06F 40/284

(52) U.S. Cl. CPC G01C 21/38; G06F 40/284; G06N 5/04

(57) ABSTRACT

The present invention relates to systems and associated methods for generating geo-coordinates for any given geographic element such as an address, while using unstructured or structured address data. According to the embodiments of the present invention, a region is divided into grids with each grid encompassing certain addresses with their locations. A grid is then treated as a label for said addresses and with the <address, grid> paired data, an appropriate grid for a new address is then predicted based on the correspondence of tokens between the address and the grid. The centroid of the predicted grid is then outputted as the latitude, longitude coordinates for the address.

### FIELD OF INVENTION

In general, the present invention relates to generating geographical coordinates. More specifically, the present invention relates to systems and methods for predicting geocodes for a given geographic element.

### BACKGROUND

Geocoding is the process of determining geo-coordinates for a given set of geocode elements. The geocode elements can be text addresses, street intersections, city, postal codes, etc.

Geocoding is a well explored problem in the spatial science and geographical science domain. Most of the existing techniques for geocoding are designed for well-organised and structured city layouts, where reliance is placed on well-formed, structured addresses and high quality reference corpora. That is, most existing geocoding techniques are dependent on a structured reference data corpora, and the actual geolocation of a complete address or that of individual address tokens must be known. However, geocoding becomes a much harder problem in places where there is no standardized way to write an address and the formats are varied and highly unstructured, and where high-quality, large-scale map corpora do not exist. For instance, while a typical address should have a house number, building name, street name, sub-locality, locality, landmark, city, state and pin code, most people tend to miss some of these tags, or not write them in a hierarchical order or provide unnecessary information. In addition, text addresses are often full of typographical errors and are misspelled by different users having different understanding of the address. This introduces a lot of noise in the user address data.

Some of the known approaches for geo-coding rely on parsing, tagging and/or chunking the address which again requires a reference data corpus, structured addresses and building a separate model trained to parse/tag/chunk an address, thus, increasing the overall complexity and the processing resources associated therewith. Further, parsing the unstructured address into chunks, for example, based on heuristics, not only has low efficiency but may also miss some chunks if they are added newly or not considered in the heuristics. Moreover, while using such a model, in retrieving a polygon (grid for a region) corresponding to a chunk from the delivered addresses, if an actual chunk is missed then its corresponding polygon will be inaccurate.

The proliferation of industries providing at-home services (ecommerce, ride-sharing, hyperlocal, etc.) has led to abundant geo-location delivery data, which can be effectively used for geocoding. The field executives (or delivery agents) often capture geo-coordinates (latitude, longitude) of different locations in an area on a GPS sensor while delivering shipments at said locations with known addresses. However, said data may be inaccurate due to poor network connectivity or due to human error, for instance, the executive marking the shipment as delivered at the delivery address in any information capturing device, but only after reaching the delivery hub. This introduces noise in the recorded geo-coordinates. The presence of noise in the delivered data reduces the accuracy of the polygon. In such models, if the retrieved polygon is larger than the actual one, it decreases the precision of the model as the overlapping area might be large and thus its centroid might be far from the original location. On the other hand, if the polygon is smaller than the actual one, then it might fail to correctly overlap which again decreases the precision.

Further, the known approaches for determining geographical coordinates may fail to produce correct results in case of misspellings or use of a different variation of the words used in the address by different people. For instance, the address token “Kormangala”, may be written in at least 4 variants by customers—“Koramangla”, “Koramangala”, “Koramanagala”, “Kormangla”. That is, in case of any misspellings, the chunking fails.

Thus, the existing systems invariably suffer from various problems such as inability to locate the geocodes for addresses that are misspelt, are unstructured or do not follow any particular standard way of writing, or are computationally suboptimal and complex.

In view of the above shortcomings of the existing systems, novel and improved solutions which not only substantially overcome the problems of the prior art but also enable prediction of geocoding for any given geographic element with improved accuracy and flexibility without any high quality structured reference corpora are desired.

### OBJECTS OF THE INVENTION

It is an object of the invention to be able to use unstructured and even poorly written address data to predict geo-coordinates for such address.

It is another object of the present invention to improve the accuracy of the predicted geolocation for any given address and to reduce processing resources.

It is a further objective of the present invention to obviate the need for parsing address text into chunks, tagging and need of structured data, a reference data corpus or building a separate model trained to parse/tag/chunk an address.

Yet another object of the invention is to minimize the impact of misspellings in determining the geo-coordinates.

Yet another object of the present invention is to minimize the impact of ordering of the address tokens.

These and other embodiments of the present disclosure will also become readily apparent to those skilled in the art from the following detailed description of the embodiments with reference to the attached figure, the disclosure not being limited to any particular embodiments disclosed.

### BRIEF DESCRIPTION OF THE DRAWINGS

For a better understanding of the embodiments of the systems and methods described herein, and to show more clearly how they may be carried into effect, reference will now be made, by way of example, to the accompanying drawings, herein:

FIG. 1 illustrates an exemplary network environment including a system for predicting geo-coordinates for a given geographic element, in accordance with an embodiment of the present invention.

FIG. 2 illustrates an overview of a system for predicting geo-coordinates for a given geographic element, in accordance with an embodiment of the present invention.

FIG. 3 illustrates an exemplary block diagram for predicting geo-coordinates for a given geographic element, in accordance with an embodiment of the present invention.

FIGS. 4A and 4B illustrate a diagrammatic representation of the levels involved in the trained model, in accordance with an embodiment of the present invention.

FIG. 5 illustrates an exemplary method for predicting geo-coordinates for a given geographic element, in accordance with an exemplary embodiment of the present invention.

### DESCRIPTION OF THE INVENTION

Exemplary embodiments now will be described with reference to the accompanying drawings. The disclosure may, however, be embodied in many different forms and should not be construed as limited to the embodiments set forth herein; rather, these embodiments are provided so that this disclosure will be thorough and complete, and will fully convey the scope to those skilled in the art. The terminology used in the detailed description of the particular exemplary embodiments illustrated in the accompanying drawings is not intended to be limiting.

The specification may refer to “an”, “one” or “some” embodiment(s) in several locations. This does not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “includes”, “comprises”, “including” and/or “comprising” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include operatively connected or coupled. As used herein, the term “and/or” includes any and all combinations and arrangements of one or more of the associated listed items.

Unless otherwise defined, all terms (including technical and scientific terms) used herein have the same meaning as commonly understood by one of ordinary skill in the art to which this disclosure pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The figure depicts a simplified structure only showing some elements and functional entities, whose implementation may differ from what is shown. The connections shown are logical connections; the actual physical connections may be different. It is apparent to a person skilled in the art that the structure may also comprise other functions and structures.

Also, all logical units described and depicted in the figures include the software and/or hardware components required for the unit to function. Further, each unit may comprise within itself one or more components which are implicitly understood. These components may be operatively coupled to each other and be configured to communicate with each other to perform the function of the said unit.

All the embodiments as herein described with respect to the present invention are applicable to the method and the corresponding system.

The term “Grid” as mentioned herein refers to division of a region into various sub-regions at various resolutions. For instance, the grid system by Uber where the entire earth region is divided into grids at various resolutions i.e. with the grid area varying from 4 million sq·km to 1 sq. m. Grid H3 has different resolutions. For instance, resolutions 8, 9 and 10 have average hexagon edge length 461, 174 and 66 meters respectively.

The invention encompasses dividing an entire pincode area into grids and for a given address, predict which grid it belongs. The latitude, longitude coordinates for the given address are predicted as the centroid of this grid. The present disclosure transforms the technical problem of predicting geo-coordinates for a given address as a classification problem such that any text-classification methodology can be utilized.

In accordance with the present invention, a region is divided into a plurality of small grids such that each grid encompasses certain addresses along with their respective locations. Each of the known addresses is associated with one of the plurality of grids, the plurality of grids enclosing the locations corresponding to the addresses. Each grid is then treated as a label for those addresses. A model with the paired data <address, grid> is trained to learn correspondence between tokens of the address and grids so as to predict the most appropriate grid(s) for a new address. This avoids the requirement of a structured reference data, the parsing/tagging/chunking of address and building a separate model trained to parse/tag/chunk an address.

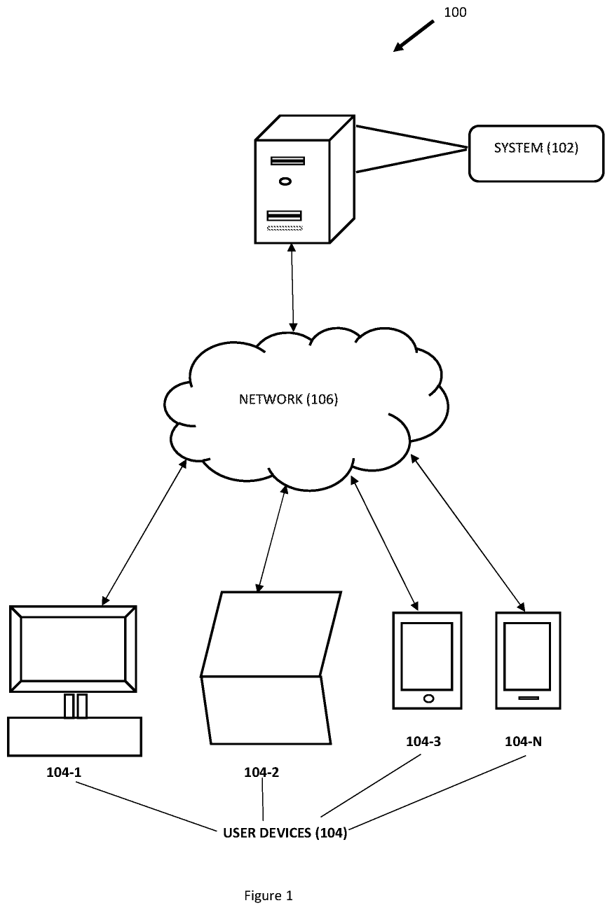

FIG. 1 illustrates an exemplary network environment 100 including a system 102 for predicting geo-coordinates for a given geographic element, in accordance with an embodiment of the present disclosure. In one embodiment, the system 102 enables predicting geo-coordinates for a given geographical element such as a text address. The present application provides the ability to utilize unstructured address data (in addition to structured address data) to predict geo-coordinates for any geographical element such as text addresses, street intersections, city, postal codes, etc. The address may be one of a new address or a previously known address. The system 102 is configured to determine geo-coordinates by implementing a model from a training file comprising the one or more predetermined plurality of predefined grids and associated addresses. The present system encompasses predicting the geo-coordinates based on the geographical element data with known associated geographical coordinates or grid regions such as postal addresses, location.

Although the present disclosure is explained considering that the system 102 is implemented at a server, the system 102 may also be implemented in a variety of computing systems, such as a laptop computer, a desktop computer, a notebook, a workstation, a mainframe computer, a network server, a portable electronic device and the like. In one embodiment, the system 102 may be implemented in a cloud-based environment. The system 102 is accessed by multiple users through one or more user devices 104-1, 104-2 . . . 104-N, collectively referred to as user devices 104 hereinafter, or applications residing on the user devices 104. Examples of the user devices 104 include, but are not limited to, a portable computer, a personal digital assistant, a handheld device, and a workstation. The user devices 104 may be communicatively coupled to the system 102 through a network 106.

In one embodiment, the network 106 may be a wireless network, a wired network, or a combination thereof. The network 106 may be implemented as one of the different types of networks, such as intranet, local area network LAN, wide area network WAN, the internet, etc. The network 106 may either be a dedicated network or a shared network. The shared network may represent an association of the different types of networks that use a variety of protocols e.g., Hypertext Transfer Protocol HTTP, Transmission Control Protocol/Internet Protocol TCP/IP, Wireless Application Protocol WAP, etc. to communicate with one another. Further, the network 106 may include a variety of network devices, including routers, bridges, servers, computing devices, storage devices, etc.

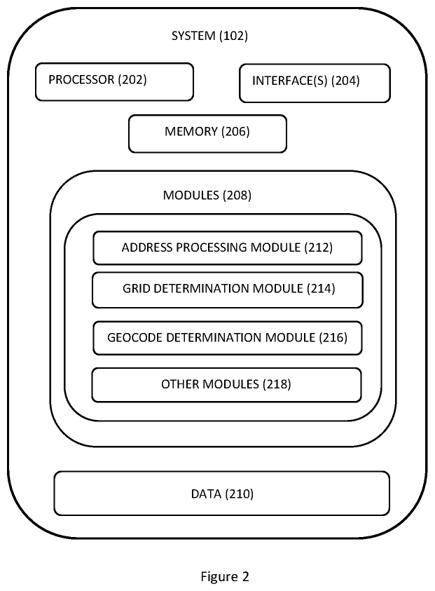

FIG. 2 illustrates an exemplary system for implementing the prediction of geocoding for any given address, in accordance with an embodiment of the present invention. In one embodiment, the system 102 may include at least one processing unit 202, an input/output (I/O) interface 204, a memory 206, modules 208 and data 210. The at least one processing unit 202 may be implemented as one or more microprocessors, microcomputers, microcontrollers, digital signal processors, central processing units, state machines, logic circuitries, and/or any devices that manipulate signals based on operational instructions. Among other capabilities, at least one processor 202 may be configured to fetch and execute computer-readable instructions stored in the memory 206.

The I/O interface 204 may include a variety of software and hardware interfaces, for example, a web interface, a graphical user interface, etc. The I/O interface 204 may allow the system 102 to interact with a user through the user devices. Further, the I/O interface 204 may enable the system 102 to communicate with other computing devices, such as web servers and external data servers (not shown). The I/O interface 204 can facilitate multiple communications within a wide variety of networks and protocol types, including wired networks (e.g. LAN, cable networks, etc.) and wireless networks (e.g., WLAN, cellular networks, or satellite networks). The I/O interface 104 may include one or more ports for connecting a number of devices to one another or to another server.

The memory 206 may include a volatile memory, such as static random access memory (SRAM) and dynamic random access memory (DRAM), and/or non-volatile memory, such as read only memory (ROM), erasable programmable ROM, flash memories, hard disks, optical disks, and magnetic tapes.

The modules 208 may include routines, physical components, etc., which perform particular tasks, functions. In one embodiment, the modules 208 may include an address processing module 212, grid determination module 214, a geocode determination module 216, and other modules 218. The other modules 218 are configured to supplement applications and functions of the system 102.

The data 210, among other things, may serve as a repository for storing data processed, received, and generated by one or more of the modules 208. The data 210 may also include a system database, and other data generated from the operation of one or more modules in the other modules 218. The data 210 stores a collection of reference location readings and corresponding addresses recorded during past delivery attempts by executives. The data 210 also stores a plurality of grids and a list of all tokens from addresses occurring in any particular grid.

The address processing module 212 is configured to receive an address string for which the geo-coordinates are to be determined. The components of the address string include a combination of letters, words, subwords, numbers, punctuation, and/or other characters. The address string in a structured or an unstructured format may be entered by a user through the I/O interface 204 using the user device 104. The address processing module 212 is configured to convert an address string into tokens. The tokens correspond to the characters, words, sub words, letters or numbers present in the address string, for example, separated from each other by white space or punctuation such as a flat number, street name/number, city, state and pincode. A token may be assigned for each component of the address string.

The address processing module 212 is configured to encode the one or more tokens to generate one or more vector representations. Specifically, the address processing module 212 is configured to learn vector representations for words of a given address by breaking the words into sub-words and learning vector representations at sub-word level. Generating the one or more vector representations include learning one or more relations between the one or more tokens by an embedding technique and projecting the one or more relations to a vector space. The system 102 encompasses using any embedding technique(s) such as Word2Vec, GloVe, FastText, BERT to obtain vector representation(s) of the address string. The embedding technique learns the relation between the tokens and projects them to a vector space.

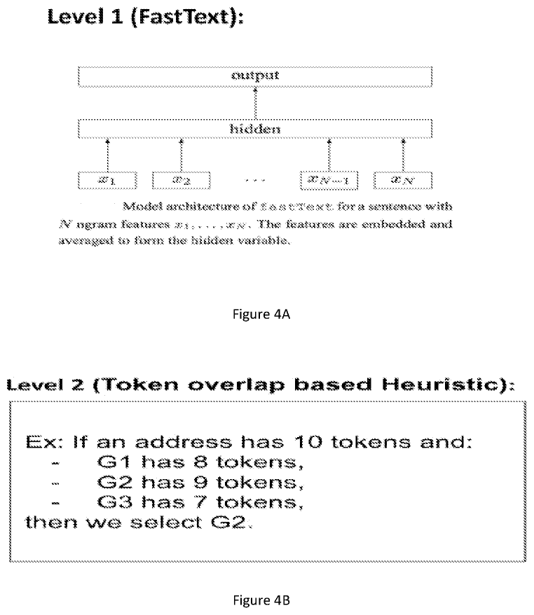

The grid determination module 214 is configured to predict at least one grid from a plurality of grids for a given address string which is likely to include the location corresponding to the address string in its associated area. The operation of the grid determination module 214 is explained below with reference to FIG. 4A. The grid determination module 214 is configured to learn a mapping of one or more vector embeddings to one or more grids through one or more learning process. The learning process inherently learns what combination of words belong to each grid. In an embodiment, where there is no relation between the words, the learning process still determines the one or more grids corresponding to vector embeddings. The grid determination module is configured to predict one or more grids using the one or more vector representations by determining a probability distribution over the one or more grids. Specifically, for a given address string, the grid determination module 214 is configured to predict a score between 0 and 1 for each grid. The higher the score, the higher the chance of the address belonging to that grid. In an embodiment, the top grid i.e. grid which has the highest probability score is predicted as the final grid as containing the location corresponding to the address string.

In another embodiment, the grid determination module 214 is configured to predict top-k grids to further improve the performance. The grid determination module 214 is then configured to determine a grid from the one or more predicted top-k grids based on a token matching process. Specifically, the grid determination module 214 is configured to determine a count of tokens of the address strings overlapping with the tokens of each grid outputted above. The grid determination module 214 is further configured to select a grid with the maximum overlap of tokens. That is, the grid with the maximum number of overlapping address tokens is then selected as the grid containing the location corresponding to the address string.

Further, the geocode determination module 216 is configured to retrieve the centroid of the selected grid, which is then determined as the geo-coordinates for the given address string. The operation of the geocode determination module 216 is explained herein below with reference to FIG. 4B.

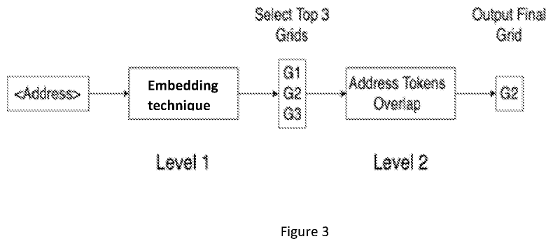

As shown in FIG. 3, a block diagram providing an overview of the method involved in the implementation of the present invention is illustrated. According to the present disclosure, for every known address, the corresponding geo-coordinates i.e. latitude & longitude and the corresponding grid the address belongs to is known from the database. With the known text address and the corresponding grid for such text address, the determination of geo-coordinates for a new address is treated as a classification problem to predict a grid to which the new address belongs to. The centroid of the grid is then predicted as the latitude and longitude coordinates.

Specifically, the present invention encompasses a bag-of-words approach, thereby eliminating the need for chunking, and allowing use of the complete address in geocode determination. A vector representation at the sub-word level is used to predict a grid polygon. This enables minimizing the impact of misspellings in the address by determining a vector near to the original vector in case of a misspelled word.

According to the present invention, in the level 1 shown in FIG. 3, text address of a new address is encoded into a vector representations and the vector representations are used to predict one or more grids for the new address such that the new address belongs to one of the predicted one or more grids. The geo-coordinates are determined by implementing a model from a training file comprising the predetermined plurality of predefined grids and associated addresses and locations. The vector representations are learned by the model and the grid for the corresponding address is determined directly. According to a preferred embodiment, one or more grids are predicted using the word vectors and a probability distribution function. Subsequently, in level 2, a token matching is performed to select one grid from the predicted one or more grids so returned from the first level. The centroid of the predicted grid is the geocode for said address.

The invention uses fixed grid, instead of retrieving grids for a chunk from the known addresses. Thus, the errors occurring due to the wrong polygon estimation are avoided. Further, the errors in using fixed grids such as wrong grid prediction are minimized by increasing the classification accuracy.

The process of geocoding performed in the two levels mentioned above is further explained below in FIGS. 4A and 4B.

As shown in FIG. 4A, according to Level-1, a machine learning model is trained in accordance with the present application, e.g. a Fasttext model. The model is trained in a supervised manner to learn vector representations for a given address as well as the grid to which the address belongs. Internally the Fasttext classifier uses a linear model. Specifically, the model learns vector representations for words of a given address by breaking the word into sub-words and learning vector representations at sub-word level. As the database includes labelled data (i.e. the grid id for an address), the vector representations for a new address are used to predict the grid label for said address.

The invention encompasses cleaning the captured addresses by removing any noise. For example, when the latitude & longitude values for a delivery address location are zero or outside a given country, etc., the outliers are removed by considering the mode of the first two digits of delivered latitude & longitude for a pin code. As an example, where a delivered point is more than 100 km from the latitude and longitude modes, then said point is discarded. In another example, the average radius of a pincode is taken to be roughly 5-10 km. Further, the invention encompasses pre-processing the cleaned address by removing punctuation and changing all letters into lowercase. Thus, the addresses are maintained with the corresponding latitude and longitude and the grid within which the address belongs to. The pre-processing steps do not require parsing address text into chunks, each chunk representing a geotag like street, locality, etc., and tagging the type of chunk, etc., thus reducing the computational requirement significantly.

In accordance with the embodiments of the present invention, the training of the model is performed as follows. Firstly, a randomized vector is assigned for every sub-word/token. Then for a given training address, word-vectors from the sub-word vectors of each token are determined. The word vectors are depicted by x1, x2, x3, etc. in FIG. 4A. One or more grids are then predicted using the word vectors and a probability distribution function.

Said vectors are fed to a feed-forward neural network with a single hidden layer, and an output layer. Subsequently, the output layer returns a probability distribution over the grid-ids. Further, a loss function is used to compute the error from the ground-truth and update the initial vectors via gradient descent.

After the set of training addresses is processed to create the model database, the system (102) uses the model to determine the geo-coordinates for a given address string. That is, once trained for given address(es), the model is used to determine a grid id, such that the centroid of the determined grid is returned as the latitude & longitude coordinates.

In an embodiment, when one or more words are determined as misspelled, some of its sub-words may be wrong, but the vectors for the rest of the sub-words are known, thus, a vector near to the original vector is determined. The model learns vector representations by predicting the neighbouring words. Unlike the words in a language which have semantic and syntactic relations, the words in an address do not have such relations and instead have the co-occurrence relation i.e. a particular “street X” will occur along with “block Y”. Thus, the present invention encompasses determining vector representations capturing such co-occurrences. As the vectors at sub-word level are learned, this minimizes the impact of misspellings. Further, the present method is independent of the ordering of the tokens. Instead, it is determined if two particular tokens occur together independent of which token occurs first, as usually happens in address writing by different people. Thus, the present method is effective when different users follow different formats for writing the same address and jumble the tokens.

With reference to FIG. 4B, there shown is a token matching process performed at level 2 to select a grid from the one or more top grids predicted from the plurality of grids at level 1 shown in FIG. 4A. The selection of a grid from one or more top grids using the token matching process further improves the prediction accuracy.

Specifically, a list of all tokens from addresses occurring in a particular grid is saved. In accordance with Level 2, in order to predict geo-coordinates of a physical location of a given address, a given address is divided into tokens, the tokens correspond to one or more characters, letters, words, sub words or numbers in the address string. Next, a number of tokens from the address string overlapping with tokens in each grid of the one or more grids obtained in level 1 is determined. The grid with maximum number of overlapping tokens is then selected. For instance, an address, “Flat 11, Pavani Lakeview, 2nd main road, JCR layout, Kadubeesanahalli” has 10 tokens. Generally, the top 3 grids (from Level 1) are close to each other, thus, making it confusing to select one grid from within the nearby grids. Using the higher level tokens like “JCR layout, Kadubeesanahalli” the model is able to narrow down to the 3 grids G1, G2 & G3. The number of overlapping tokens of the address with the grids G1, G2 & G3 is then determined such that the higher level tokens “JCR layout, Kadubeesanahalli” are common across all the grids and there is difference in the low level tokens like “Flat 11, Pavani Lakeview, 2nd main road”. Thus, out of the 10 tokens, if Grid 1 has 8 tokens, Grid 2 has 9 tokens and Grid 3 has 7 tokens, grid G2 is selected as the output grid. The above mentioned two level process has been found to achieve a significant improvement in the classification accuracy.

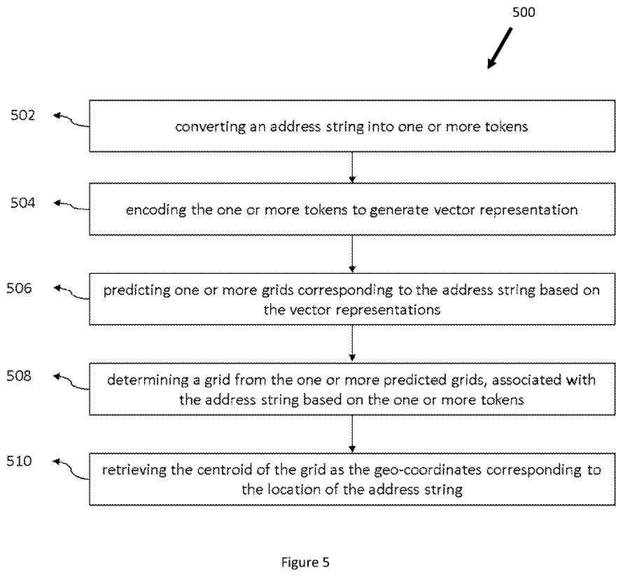

FIG. 5 illustrates a flowchart of a method for predicting geo-coordinates for a given geographic element, in accordance with an embodiment of the present invention. The method of FIG. 5 may be implemented by the system of FIG. 2. At step 502, an address string is received and the address string is converted into one or more tokens. The one or more tokens correspond to one or more characters, letters, words, sub words or numbers of the address string. The address string may be structured or unstructured or a combination thereof.

At step 504, the one or more tokens are encoded to generate one or more vector representations. Generating the one or more vector representations include learning one or more relations between the one or more tokens by an embedding technique and projecting the one or more relation to a vector space. Learning one or more relations include learning a mapping of vector embeddings to one or more grids through learning combinations of words belonging to each grid.

At step 506, the vector representations are used to predict one or more top grids from a plurality of predefined grids such that the location corresponding to the address string belongs to one of the predicted grids.

At step 508, a grid from the one or more predicted grids associated with the address string is determined based on a matching between tokens of the address string and the tokens of each of the one or more predicted grids.

Finally, at step 510, the centroid of the grid determined at step 508 is retrieved as the geo-coordinates corresponding to the location of the address string.

The prediction of geo-coordinates as disclosed by the present invention may be used in a variety of applications, such as in navigation so as to reach a particular address point, in route planning so as to plan the sequence of delivering shipments, in detecting a fake attempt at delivery so as to detect whether a field executive actually reached the delivery location or not.

Although the present invention has been described in considerable detail with reference to certain preferred embodiments and examples thereof, other embodiments and equivalents are possible. Even though numerous characteristics and advantages of the present invention have been set forth in the foregoing description, together with functional and procedural details, the disclosure is illustrative only, and changes may be made in detail, especially in terms of the structuring and implementation within the principles of the invention to the full extent indicated by the broad general meaning of the terms. Thus various modifications are possible of the presently disclosed system and method without deviating from the intended scope and spirit of the present invention.

We claim:

1. A method for determining geo-coordinates for an address, the method comprising:
converting an address string into one or more tokens, the one or more tokens correspond to one or more characters, letters, words, sub words or numbers in the address string;
encoding the one or more tokens to generate one or more vector representations;
predicting one or more grids from a plurality of predefined grids corresponding to the address string based on the one or more vector representations;
determining a grid from the one or more predicted grids, associated with the address string based on the one or more tokens; and
retrieving the centroid of the grid as the geo-coordinates corresponding to location of the address string.

2. The method as claimed in claim 1, wherein the address string is one of an unstructured address string and a structured address string.

3. The method as claimed in claim 1, wherein the geo-coordinates are determined by implementing a model from a training file comprising the one or more predetermined plurality of predefined grids and associated addresses.

4. The method as claimed in claim 1, wherein generating the one or more vector representations includes learning one or more relations between the one or more tokens by an embedding technique and projecting the one or more relations to a vector space.

5. The method as claimed in claim 1, further comprising learning a mapping of vector embeddings to one or more grids through learning combinations of words belonging to each grid.

6. The method as claimed in claim 1, wherein predicting one or more grids using the one or more vector representations includes determining a probability distribution over the one or more grids.

7. The method as claimed in claim 1, wherein determining a grid from the one or more predicted grids includes:
determining, for each predicted grid, a number of tokens of the address string overlapping with the tokens of the predicted grid; and
selecting the grid with the maximum number of overlapping tokens.

8. A system (102) for determine geo-coordinates for an address, comprising:
an address processing module (212) to:
convert an address string into one or more tokens, the one or more tokens correspond to one or more characters, letters, words, sub words or numbers in the address string;
encode the one or more tokens to generate one or more vector representations; and
a grid determination module (214) to:
predict one or more grids from a plurality of predefined grids corresponding to the address string based on the one or more vector representations;
determine a grid from the one or more predicted grids, associated with the address string based on the one or more tokens; and
a geocode determination module (216) to retrieve the centroid of the grid as the geo-coordinates corresponding to location of the address string.

9. The system as claimed in claim 8, wherein the system is configured to determine one of an unstructured address string and a structured address string.

10. The system as claimed in claim 8, wherein the system is configured to determine geo-coordinates by implementing a model from a training file comprising the one or more predetermined plurality of predefined grids and associated addresses.

11. The system as claimed in claim 8, wherein the address processing module (212) is configured to generate one or more vector representations by learning one or more relation between the one or more tokens by an embedding technique and projecting the one or more relations to a vector space.

12. The system as claimed in claim 8, wherein the grid determining module (214) is configured to learn a mapping of vector embeddings to one or more grids through learning combination of words belonging to each grid.

13. The system as claimed in claim 8, wherein the grid determination module (214) is configured to predict one or more grids using the one or more vector representations by determining a probability distribution over the one or more grids.

14. The system as claimed in claim 8, wherein the grid determination module (214) is configured to determine a grid from the one or more predicted grids by:
determining, for each predicted grid, a number of tokens of the address string overlapping with the tokens of the predicted grid; and
selecting the grid with the maximum number of overlapping tokens.
